(19) United States
(12) Patent Application Publication
(10) Pub. No.: US 2016/0233501 A1
(43) Pub. Date: Aug. 11, 2016

(54) NEGATIVE ACTIVE MATERIAL FOR RECHARGEABLE LITHIUM BATTERY AND RECHARGEABLE LITHIUM BATTERY COMPRISING SAME

(71) Applicant: SAMSUNG SDI CO., LTD., Yongin-si (KR)

(72) Inventors: Su-Kyung LEE, Yongin-si (KR); Sang-Hyuck AHN, Yongin-si (KR); Deok-Hyun KIM, Yongin-si (KR); Xianhui MENG, Yongin-si (KR); Young Jin CHOI, Yongin-si (KR); Sang-Pil KIM, Yongin-si (KR); Yong-Chan YOU, Yongin-si (KR)

(21) Appl. No.: 15/001,555

(22) Filed: Jan. 20, 2016

(30) Foreign Application Priority Data
Feb. 9, 2015 (KR) 10-2015-0019672

(51) Int. Cl. H01M 4/38; H01M 10/0525

(52) U.S. Cl. CPC H01M 4/386; H01M 10/0525; H01M 2220/30

(57) ABSTRACT

A negative active material for a rechargeable lithium battery and a rechargeable lithium battery including the same are provided, and the negative active material includes a Si-based alloy; a first graphite material; and a second graphite material having a different average particle diameter from the first graphite material.

### INCORPORATION BY REFERENCE TO ANY PRIORITY APPLICATIONS

Any and all priority claims identified in the Application Data Sheet, or any correction thereto, are hereby incorporated by reference under 37 CFR 1.57.

This application claims priority to and the benefit of Korean Patent Application No. 10-2015-0019672 filed in the Korean Intellectual Property Office on Feb. 9, 2015, the disclosure of which is incorporated in the entirety by reference.

### BACKGROUND

1. Field

This disclosure relates to negative active material for a rechargeable lithium battery and a rechargeable lithium battery including the same are disclosed.

2. Description of the Related Technology

A rechargeable lithium battery has recently drawn attention as a power source for small portable electronic devices. It uses an organic electrolyte solution and thereby, has more than twice as high discharge voltage as a battery using an alkali aqueous solution and accordingly, has a high energy density.

A rechargeable lithium battery includes a positive electrode, a negative electrode, a separator interposed between the positive electrode, and the negative electrode and an electrolyte solution, and the positive electrode and negative electrode includes a current collector and an active material layer.

As for positive active materials of the positive electrode, a lithium-transition metal oxide having a structure capable of intercalating lithium ions, such as LiCoO₂, LiMn₂O₄, LiNi₁₋ₓCoₓO₂ (0<x<1), and the like may be used.

As for negative active materials of the negative electrode, various carbon-based materials such as artificial graphite, natural graphite, and hard carbon that may intercalate and deintercalate have been used, and a mixture of a Si-based material and a carbon-based material may be used.

### SUMMARY

One embodiment provides a negative active material for a rechargeable lithium battery by decreasing expansion of the negative active material during charge and discharge of the rechargeable lithium battery and thus, suppressing deformation of the battery and improving its cycle-life.

Another embodiment provides a rechargeable lithium battery including the negative active material.

A negative active material for a rechargeable lithium battery according to one embodiment includes a Si-based alloy; a first graphite material; and a second graphite having a different average particle diameter from the first graphite material.

A ratio of the average particle diameter of the first graphite material relative to that of the second graphite material may be about 0.5 to about 0.92.

The average particle diameter of the first graphite material may be about 8 μm to about 28 μm.

The average particle diameter of the second graphite material may be about 10 μm to about 30 μm.

A weight ratio of the first graphite material and the second graphite material may be about 1:9 to about 9:1.

An amount of the Si-based alloy may be about 5 wt % to about 25 wt % based on the total amount 100 wt % of the negative active material.

The Si-based alloy may be Si-Q, wherein Q is selected from an alkali metal, an alkaline-earth metal, a Group-13 element, a Group-14 element, a Group-15 element, a Group-16 element, a transition metal, a rare earth element and a combination thereof, but not Si. Herein, the Q may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The Si-based alloy may be a Si—Fe alloy.

Another embodiment provides a rechargeable lithium battery including a negative electrode including the negative active material; a positive electrode including a positive active material; and a non-aqueous electrolyte.

Another embodiment provides a rechargeable lithium battery wherein the negative active material layer comprises of about 95 wt % to about 99 wt % of negative active material based on the total weight of the negative active material layer.

Another embodiment provides a rechargeable lithium battery comprising of the negative active material wherein a ratio of the average particle diameter of the first graphite material relative to that of the second graphite material is about 0.5 to about 0.92.

Another embodiment provides a rechargeable lithium battery comprising of the negative active material wherein the average particle diameter of the first graphite material is about 8 μm to about 28 μm.

Another embodiment provides a rechargeable lithium battery comprising of the negative active material wherein the average particle diameter of the second graphite material is about 10 μm to about 30 μm.

Another embodiment provides a rechargeable lithium battery comprising of the negative active material wherein a weight ratio of the first graphite material and second graphite material is about 1:0.9 to about 9:0.1.

Another embodiment provides a rechargeable lithium battery comprising of the negative active material wherein an amount of the Si-based alloy is about 5 wt % to about 25 wt % based on the total amount 100 wt % of the negative active material.

Another embodiment provides a rechargeable lithium battery comprising of the negative active material wherein the Si-based alloy is Si-Q, wherein Q is selected from an alkali metal, an alkaline-earth metal, a Group 13 element, a Group 14 element, a Group 15 element, a Group 16 element, a transition metal, a rare earth element and a combination thereof, but not Si.

Another embodiment provides a rechargeable lithium battery comprising of the negative active material wherein an amount of the first graphite material may be about 50 wt % to about 90 wt % based on the total amount 100 wt % of the negative active material.

Another embodiment provides a rechargeable lithium battery comprising of the negative active material wherein an amount of the second graphite material may be about 5 wt % to about 45 wt % based on the total amount 100 wt % of the negative active material.

The negative active material for a rechargeable lithium battery according to an embodiment uses two kinds of graphite having different average particle diameters and a Si-based alloy and is suppressed from volume expansion during charging and discharging processes of the rechargeable lithium battery and as a result, may prevent deformation of the battery and provide the battery with excellent cycle-life characteristics.

### BRIEF DESCRIPTION OF THE DRAWINGS

FIG. 1 shows a rechargeable lithium battery according to one embodiment.

FIG. 2 is a graph showing discharge capacity retention of rechargeable lithium batteries respectively using negative electrodes of Example 2 and Reference Example 1.

FIG. 3 is a graph showing discharge capacity retention of rechargeable lithium batteries respectively using negative electrodes of Examples 1 and 2 and Comparative Example 3.

### DETAILED DESCRIPTION

Hereinafter, some embodiments are described in detail. However, these embodiments are only exemplary, and this disclosure is not limited thereto. As used herein, when specific definition is not otherwise provided, it will be understood that when an element such as a layer, film, region, or substrate is referred to as being “on” another element, it can be directly on the other element or intervening elements may also be present.

A negative active material for a rechargeable lithium battery according to one embodiment includes a Si-based alloy, a first graphite material and a second graphite material having a different average particle diameter from the first graphite.

As used herein, the average particle diameter refers to D50.

In one embodiment, the average particle diameter of the second graphite material may be larger than that of the first graphite material.

A ratio of the average particle diameter of the first graphite material relative to that of the second graphite material (the average particle diameter of first graphite material/the average particle diameter of the second graphite material) may be about 0.5 to about 0.92. When the ratio of the average particle diameter of the first graphite material relative to that of the second graphite material is within the range, the negative active material is suppressed from expansion during charge and discharge of a rechargeable lithium battery.

In this way, when two kinds of first and second graphite materials having different average particle diameters are used with a Si-based alloy as a negative active material, the negative active material may be more effectively suppressed from expansion during charging and discharging process of a battery. The reason is that the Si-based alloy is more uniformly distributed among the graphite materials. However, when one kind of graphite, for example, either one of a first graphite material or a second graphite material, or graphite material having an average particle diameter ranging from about 12 μm to about 15 μm is used with a Si-based alloy as a negative active material, the Si-based alloy may expand during charging and discharging process of a battery, increase overall expansion of a negative electrode and thus, result in deformation of a battery and deteriorate cycle-life characteristics of the battery.

As used herein, the above two kinds of graphite material do not necessarily indicate two totally different kinds of graphite material but graphite material having two different average particle diameters. Accordingly, one kind of graphite material indicates graphite material having a substantially similar average particle diameter.

In one embodiment, the first and second graphite materials may include artificial graphite, natural graphite or a combination thereof but are not limited thereto, for example, may be the same, as far as they have an average particle diameter ratio within the range.

The average particle diameter of the first graphite material may be about 8 μm to about 28 μm, for example about 15 μm to about 24 μm. The average particle diameter of the average particle diameter of the second graphite material may be about 10 μm to about 30 μm, for example about 16 μm to about 27 μm.

When the first and second graphite materials respectively have an average particle diameter within the ranges, conductivity and rate capability of an electrode may be improved, and an active material may be effectively suppressed from expansion. In addition, when two kinds of graphite material having different average particle diameters are used, effects of both graphite materials having a larger average particle diameter and graphite material having a smaller average particle diameter may be obtained. In other words, the effects for improving a capacity, efficiency, and cycle-life and the effect for easily performing a compression all may be obtained.

An average particle diameter of the Si-based alloy may be about 1 μm to about 6 μm. When the Si-based alloy has an average particle diameter within the range, a slurry type negative active material composition for preparing an electrode may be easily prepared without a problem such as gelation and the like, the Si-based alloy may be well dispersed in an electrode, and thus, an active material may be prevented from excessive expansion.

A weight ratio of the first graphite material and the second graphite material may be about 1:9 to about 9:0.1, for example about 2:0.8 to about 8:0.2. When the weight ratio of the first graphite material and second graphite material is within the weight ratio range, the effects by using a mixture of two different kinds of graphite materials may be further improved.

An amount of the Si-based alloy may be about 5 wt % to about 25 wt %, for example about 10 wt % to about 15 wt % based on the total amount 100 wt % of the negative active material.

An amount of the first graphite material may be about 50 wt % to about 90 wt %, for example about 60 wt % to about 80 wt % based on the total amount 100 wt % of the negative active material. When the first graphite material is used within the range, capacity, efficiency and cycle-life characteristics of the first graphite material may be effectively obtained.

An amount of the second graphite material may be about 5 wt % to about 45 wt %, for example about 5 wt % to about 25 wt % based on the total amount 100 wt % of the negative active material. When the second graphite material is used within the range, an active material layer may be easily compressed in a process of manufacturing an electrode, and thus, an electrode may be easily manufactured.

The Si-based alloy may be Si-Q, wherein Q is selected from an alkali metal, an alkaline-earth metal, a Group 13 element, a Group 14 element, a Group 15 element, a Group 16 element, transition metal, a rare earth element and a combination thereof, but not Si. Herein, the Q may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof. In one embodiment of the present invention, specific examples of the Si-based alloy may be Si—Fe.

Another embodiment provides a negative electrode including a current collector and a negative active material layer formed on the current collector and including the negative active material. The current collector may include one selected from a copper foil, a nickel foil, a stainless steel foil, a titanium foil, a nickel foam, a copper foam, a polymer substrate coated with a conductive metal, and a combination thereof, but is not limited thereto.

In the negative active material layer, the negative active material may be included in an amount of about 95 wt % to about 99 wt % based on the total weight of the negative active material layer.

The negative active material layer may include a binder and optionally, a conductive material. The negative active material layer may include about 1 wt % to about 5 wt % of a binder based on the total weight of the negative active material layer. When the negative active material layer includes a conductive material, the negative active material layer includes about 90 wt % to about 98 wt % of the negative active material, about 1 wt % to about 5 wt % of the binder, and about 1 wt % to about 5 wt % of the conductive material.

The binder improves binding properties of negative active material particles with one another and with a current collector.

The binder may be a non-aqueous binder, an aqueous binder, or a combination thereof.

The non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The aqueous binder may be a rubber-based binder or a polymer resin binder.

The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof.

The polymer resin binder may be selected from polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol and a combination thereof.

When the aqueous binder is used as a negative electrode binder, a cellulose-based compound may be further used to provide viscosity. The cellulose-based compound includes one or more of carboxylmethyl cellulose, hydroxypropylmethyl cellulose, methyl cellulose, or alkali metal salts thereof. The alkali metal may be Na, K, or Li. Such a thickener may be included in an amount of about 0.1 parts by weight to about 3 parts by weight based on 100 parts by weight of the negative active material.

The conductive material is included to provide electrode conductivity. Any electrically conductive material may be used as a conductive material unless it causes a chemical change. Examples of the conductive material include a carbon-based material such as natural graphite, artificial graphite, carbon black, acetylene black, ketjen black, and a carbon fiber, a metal-based material of a metal powder or a metal fiber including copper, nickel, aluminum, or silver, or a conductive polymer such as a polyphenylene derivative; or a mixture thereof.

Another embodiment provides a rechargeable lithium battery including the negative electrode, a positive electrode including a positive active material, and an electrolyte solution.

The positive electrode may include a positive current collector and a positive active material layer formed on the positive current collector. The positive active material may include lithiated intercalation compounds that reversibly intercalate and deintercalate lithium ions. The lithium metal oxide may specifically be a composite oxide of at least one metal selected from cobalt, manganese, nickel, and aluminum, and lithium. More specifically, the compounds represented by one of the following chemical formulae may be used. LiₐA_{1-b}X_{b}D′₂ (0.90≦a≦1.8, 0≦b≦0.5); LiₐA_{1-b}X_{b}O_{2-c}D′_{c} (0.90≦a≦1.8, 0≦b≦0.5, 0≦c≦0.05); LiₐE_{1-b}X_{b}O_{2-c}D′_{c} (0≦b≦0.5, 0≦c≦0.05); LiₐE_{2-b}X_{b}O_{4-c}D′_{c} (0≦b≦0.5, 0≦c≦0.05); LiₐNi_{1-b-c}Co_{b}X_{c}D′_{α} (0.90≦a≦1.8, 0≦b≦0.5, 0≦c≦0.5, 0≦a≦2); LiₐNi_{1-b-c}CO_{b}X_{c}O_{2-α}T′_{α} (0.90≦a≦1.8, 0≦b≦0.5, 0≦c≦0.05, 0≦a≦2); LiₐNi_{1-b-c}Co_{b}X_{c}O_{2-α}T′₂ (0.90≦a≦1.8, 0≦b≦0.5, 0≦c≦0.05, 0≦a≦2); LiₐNi_{1-b-c}Mn_{b}X_{c}D′_{α} (0.90≦a≦1.8, 0≦b≦0.5, 0≦c≦0.05, 0≦a≦2); LiₐNi_{1-b-c}Mn_{b}X_{c}O_{2-α}T′_{α} (0.90≦a≦1.8, 0≦b≦0.5, 0≦c≦0.05, 0≦a≦2); LiₐNi_{1-b-c}Mn_{b}X_{c}O_{2-α}T′₂ (0.90≦a≦1.8, 0≦b≦0.5, 0≦c≦0.05, 0≦a≦2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}G_{c}O₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1) LiₐCoG_{b}O₂ (0.90≦a≦1.8, 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, 0.001≦b≦0.1); LiₐMn_{1-g}G_{g}PO₄ (0.90≦a≦1.8, 0≦g≦0.5); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); LiₐFePO₄ (0.90≦a≦1.8).

In the above chemical formulae, A is selected from Ni, Co, Mn, and a combination thereof; X is selected from Al, Ni, Co, Mn, Cr, Fe, Mg, Sr, V, a rare earth element, and a combination thereof; D′ is selected from O, F, S, P, and a combination thereof; E is selected from Co, Mn, and a combination thereof; T′ is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by using these elements in the compound. For example, the method may include any coating method such as spray coating, dipping, and the like, but is not illustrated in more detail since it is well-known to those who work in the related field.

In the positive active material layer, the positive active material may be included in a ratio of about 90 wt % to about 98 wt % based on the total weight of the positive active material layer.

The positive active material layer may also include a binder and a conductive material. Herein, each amount of the binder and conductive material may be about 1 wt % to about 5 wt % based on the total weight of the positive active material layer.

The binder improves binding properties of positive active material particles with one another and with a current collector. Examples of the binder may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to provide electrode conductivity. Any electrically conductive material may be used as a conductive material unless it causes a chemical change. Specific examples of the conductive material may be a carbon-based material such as natural graphite, artificial graphite, carbon black, acetylene black, ketjen black, denka black, carbon fiber and the like, a metal-based material such as a metal powder or a metal fiber and the like of copper, nickel, aluminum, silver, and the like, a conductive polymer such as a polyphenylene derivative and the like, or a mixture thereof.

The current collector may use Al, but is not limited thereto.

The negative electrode and positive electrode may be manufactured by a method including mixing each active material, a conductive material, and a binder in a solvent to prepare active material compositions, and coating the active material compositions on a current collector. The electrode manufacturing method is well known, and thus is not described in detail in the present specification. The solvent includes N-methylpyrrolidone and the like, but is not limited thereto. In addition, when the negative electrode is a water-soluble binder, the solvent may be water during preparation of the negative active material composition.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and the like. The ester-based solvent may include methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone and the like. The alcohol-based solvent include ethyl alcohol, isopropyl alcohol, and the like, and examples of the aprotic solvent include nitriles such as R—CN (where R is a C2 to C20 linear, branched, or cyclic hydrocarbon group, a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio may be controlled in accordance with a desirable battery performance.

The carbonate-based solvent is prepared by mixing a cyclic carbonate and a linear carbonate. The cyclic carbonate and linear carbonate are mixed together in a volume ratio of about 1:1 to about 1:9. When the mixture is used as an electrolyte, it may have enhanced performance.

The non-aqueous organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by the following Chemical Formula 1.

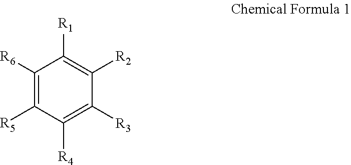

In Chemical Formula 1, R₁ to R₆ are the same or different and are selected from hydrogen, a halogen, a C1 to C10 alkyl group, a haloalkyl group, and a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate-based compound represented by the following Chemical Formula 2 to improve cycle life.

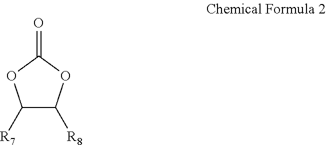

In Chemical Formula 2, R₇ and R₈ are the same or different and may be each independently hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle life may be flexibly used within an appropriate range.

The lithium salt is dissolved in an organic solvent, supplies a battery with lithium ions, basically operates the rechargeable lithium battery, and improves transportation of the lithium ions between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers, e.g. an integer of 1 to 20), LiCl, LiI and LiB(C₂O₄)₂ (lithium bis(oxalato) borate; LiBOB). The lithium salt may be used in a concentration ranging from about 0.1 M to about 2.0 M. When the lithium salt is included at the above concentration range, an electrolyte may have excellent performance and lithium ion mobility due to optimal electrolyte conductivity and viscosity.

The rechargeable lithium battery may further include a separator between the negative electrode and the positive electrode, depending on a kind of the battery. Examples of a suitable separator material include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

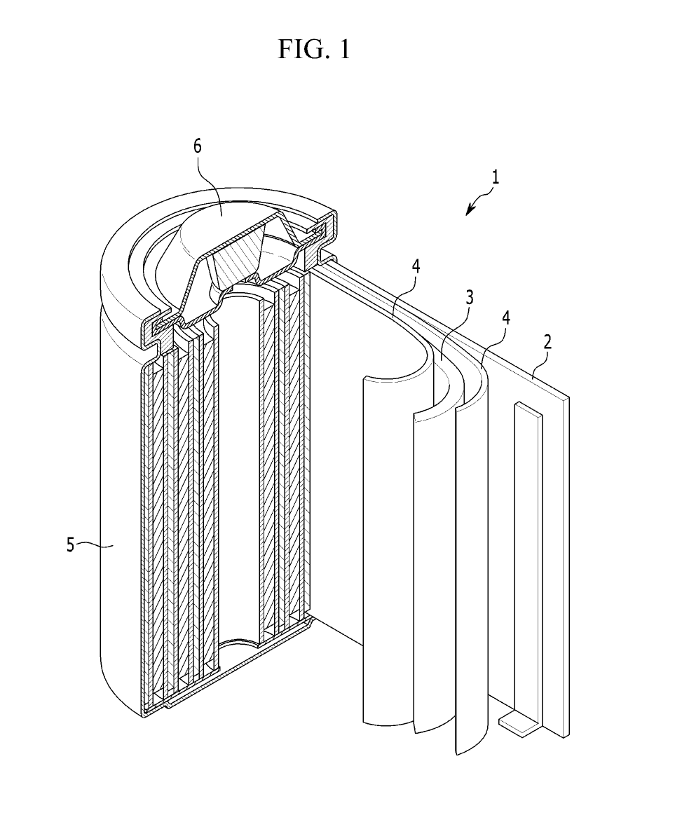

FIG. 1 shows a schematic structure of a rechargeable lithium battery according to one embodiment. As shown in FIG. 1, the rechargeable lithium battery 1 includes a positive electrode 2, a negative electrode 3, and a separator 4 disposed between the positive electrode 2 and the negative electrode 3, an electrolyte (not shown) impregnated therein, a battery case 5 including the above members, and a sealing member 6 sealing the battery case 5.

Hereinafter, the following examples and comparative examples illustrate the embodiments in more detail. However, it is understood that the disclosure is not limited by these examples.

The materials required for the preparation of the negative active material were acquired from the following sources:

Si—Fe negative active material (3M, USA)

Carboxyl methyl cellulose thickener (Nippon Paper Industries Co., Ltd., Japan)

Styrene-butadiene rubber binder (Zeon Corporation, Japan)

First graphite material (Shanshan Tech Co., Ltd. Shanghai, China)

Second graphite material (Shanshan Tech Co., Ltd. Shanghai, China)

### Example 1

Negative active material slurry having a solid content of 50 wt % was prepared by uniformly mixing 15 wt % of a Si—Fe negative active material having an average particle diameter (D50) of 3 μm, 57 wt % of second graphite material having an average particle diameter (D50) of 24 μm, 25 wt % of first graphite material having an average particle diameter (D50) of 20 μm, 1.5 wt % of a carboxyl methyl cellulose thickener, and 1.5 wt % of a styrene-butadiene rubber binder in pure water. As for the first graphite material and the second graphite material, artificial graphite was used, and the first graphite material relative to the second graphite material had an average particle diameter ratio (average particle diameter of the first graphite material/average particle diameter of the second graphite material) of about 0.83. The average particle diameter was measured by using particle size analyzer (PSA) available from Malvern instruments limited (Worcestershire, UK).

The slurry was coated on a Cu foil current collector and then, dried and compressed, manufacturing a negative electrode.

### Example 2

A negative electrode was manufactured according to the same method as Example 1 except for using artificial graphite having an average particle diameter (D50) of 15 μm as for the first graphite material. In other words, the first graphite material relative to the second graphite material had an average particle diameter ratio (average particle diameter of the first graphite material/average particle diameter of the second graphite material) of 0.625.

### Example 3

A negative electrode was manufactured according to the same method as Example 1 except for using artificial graphite having an average particle diameter (D50) of 18 μm as for the first graphite material. In other words, the first graphite material relative to the second graphite material had an average particle diameter ratio (average particle diameter of the first graphite material/average particle diameter of the second graphite material) of 0.75.

### Example 4

A negative electrode was manufactured according to the same method as Example 1 except for using 57 wt % of artificial graphite having an average particle diameter (D50) for 24 μm for the first graphite material and 25 wt % of artificial graphite having an average particle diameter (D50) of 26 μm as for the second graphite material. In other words, the first graphite material relative to the second graphite material had an average particle diameter ratio (average particle diameter of the first graphite material/average particle diameter of the second graphite material) of 0.92.

### Example 5

A negative electrode was manufactured according to the same method as Example 1 except for using artificial graphite having an average particle diameter (D50) of 17 μm as for the first graphite material. In other words, the first graphite relative to the second graphite had an average particle diameter ratio (average particle diameter of the first graphite material/average particle diameter of the second graphite material) of 0.704.

### Example 6

Negative active material slurry having a solid content of 50 wt % was prepared by uniformly mixing 10 wt % of a Si—Fe negative active material having an average particle diameter (D50) of 4 μm, 70 wt % of second graphite material having an average particle diameter (D50) of 24 μm, 20 wt % of first graphite material having an average particle diameter (D50) of 15 μm, 1.5 wt % of a carboxyl methyl cellulose thickener, and 1.5 wt % of a styrene-butadiene rubber binder in pure water. As for the first graphite material and the second graphite material, the first graphite material relative to the second graphite material had an average particle diameter ratio (average particle diameter of the first graphite material/average particle diameter of the second graphite material) of 0.625.

The slurry was coated on a Cu foil current collector and then, coated and compressed, manufacturing a negative electrode.

### Comparative Example 1

Negative active material slurry having a solid content of 50 wt % was prepared by uniformly mixing 15 wt % of a Si—Fe negative active material having an average particle diameter (D50) of 3 μm, 82 wt % of artificial graphite having an average particle diameter (D50) of 15 μm, 1.5 wt % of a carboxyl methyl cellulose thickener, and 1.5 wt % of a styrene-butadiene rubber in pure water.

The slurry was coated on a Cu foil current collector and then, dried and compressed, manufacturing a negative electrode.

### Comparative Example 2

A negative electrode was manufactured according to the same method as Comparative Example 1 except for using artificial graphite having an average particle diameter (D50) of 18 μm instead of the artificial graphite having an average particle diameter (D50) of 15 μm.

### Comparative Example 3

A negative electrode was manufactured according to the same method as Comparative Example 1 except for using artificial graphite having an average particle diameter (D50) of 20 μm instead of the artificial graphite having an average particle diameter (D50) of 15 μm.

### Comparative Example 4

A negative electrode was manufactured according to the same method as Comparative Example 1 except for using artificial graphite having an average particle diameter (D50) of 23 μm instead of the artificial graphite having an average particle diameter (D50) of 15 μm.

### Comparative Example 5

A negative electrode was manufactured according to the same method as Comparative Example 1 except for using artificial graphite having an average particle diameter (D50) of 26 μm instead of the artificial graphite having an average particle diameter (D50) of 15 μm.

### Expansion Ratio Experiment

Each negative electrode according to Examples 1 to 5 and Comparative Example 1, a lithium counter electrode, and an electrolyte solution were used to manufacture half-cells. Herein, the electrolyte solution was prepared by mixing ethylene carbonate, ethylmethyl carbonate and diethyl carbonate to prepare a solvent and dissolving 1.3 M LiPF₆ therein. The half-cell was once charged at 0.2 C, and its battery thicknesses before and after the charge was respectively measured and used to obtain its thickness increase rate. The results are provided in the following Table 1.

TABLE 1

| | Exam- | Exam- | Exam- | Exam- | Exam- |
|---|---|---|---|---|---|
| | ple 1 | ple 2 | ple 3 | ple 4 | ple 5 |
| Average particle | 3 | 3 | 3 | 3 | 3 |
| diameter (D50, μm) | | | | | |
| of Si—Fe alloy | | | | | |
| Average particle | 20 | 15 | 18 | 24 | 17 |
| diameter (D50, μm) | | | | | |
| of first graphite | | | | | |
| material | | | | | |
| Average particle | 24 | 24 | 24 | 26 | 24 |
| diameter (D50, μm) | | | | | |
| of second graphite | | | | | |
| material | | | | | |
| Average particle | 0.83 | 0.625 | 0.75 | 0.92 | 0.70 |
| diameter (D50, μm) | | | | | |
| of first graphite | | | | | |
| material/average | | | | | |
| particle diameter | | | | | |
| (D50, μm) of second | | | | | |
| graphite material | | | | | |
| Expansion improvement | 0 | 2.5 | 0.5 | 1.4 | 1.4 |
| ratio (%) | | | | | |

TABLE 2

| | Compar- | Compar- | Compar- | Compar- | Compar- |
|---|---|---|---|---|---|
| | ative | ative | ative | ative | ative |
| | Exam- | Exam- | Exam- | Exam- | Exam- |
| | ple 1 | ple 2 | ple 3 | ple 4 | ple 5 |
| Average | 3 | 3 | 3 | 3 | 3 |
| particle | | | | | |
| diameter | | | | | |
| (D50, μm) of | | | | | |
| Si—Fe alloy | | | | | |
| Average | 15 | 18 | 20 | 23 | 26 |
| particle | | | | | |
| diameter | | | | | |
| (D50, μm) of | | | | | |
| graphite | | | | | |
| Expansion | −3.8 | −0.9 | −1.5 | −0.2 | −0.5 |
| improvement | | | | | |
| ratio (%) | | | | | |

In Tables 1 and 2, the expansion improvement ratio indicates a decreased value with a reference to the thickness increase rate of Example 1 after the charge and discharge cycles. In other words, expansion improvement ratio of 2.5% for Example 2 indicates that it showed 2.5% lower thickness increase rate. In contrast expansion improvement ratio of −3.8% for Comparative Example 1 indicates that it showed 3.8% higher thickness increase rate compared to Example 1. As shown in Tables 1 and 2, lithium battery cells respectively using the negative electrodes according to Examples 1 to 5 showed a lower thickness expansion ratio than lithium battery cells respectively using the negative electrodes according to Comparative Examples 1 to 5.

### Reference Example 1

A negative electrode was manufactured according to the same method as Example 1 except for using artificial graphite having an average particle diameter (D50) of 11 um as for the first graphite material and artificial graphite having an average particle diameter (D50) of 24 um as for the second graphite material. Herein, the first graphite material relative to second graphite material had an average particle diameter ratio (average particle diameter of the first graphite material/average particle diameter of second graphite material) of about 0.46.

### Cycle-life Characteristics

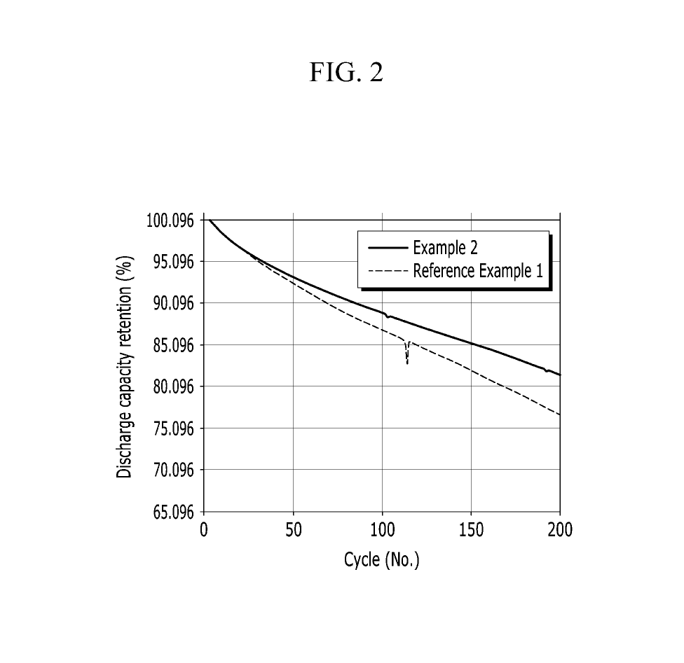

Each negative electrode according to Example 2 and Reference Example 1, a LiₓNi_{y}Co_{z}MnₖO₂ (x=1, y=⅓, z=⅓, k=⅓)/LiCoO₂ mixture (30:70 wt %) positive electrode and the electrolyte solution were used to manufacture a rechargeable lithium battery cell having theoretical capacity of 2000 mAh. The rechargeable lithium battery cell was 200 times repetitively charged and discharged at 1 C, and its discharge capacity retention was measured. The results are provided in FIG. 2. As shown in FIG. 2, Example 2 showed excellent capacity retention of a battery cell and thus, excellent cycle-life characteristics compared with Reference Example 1.

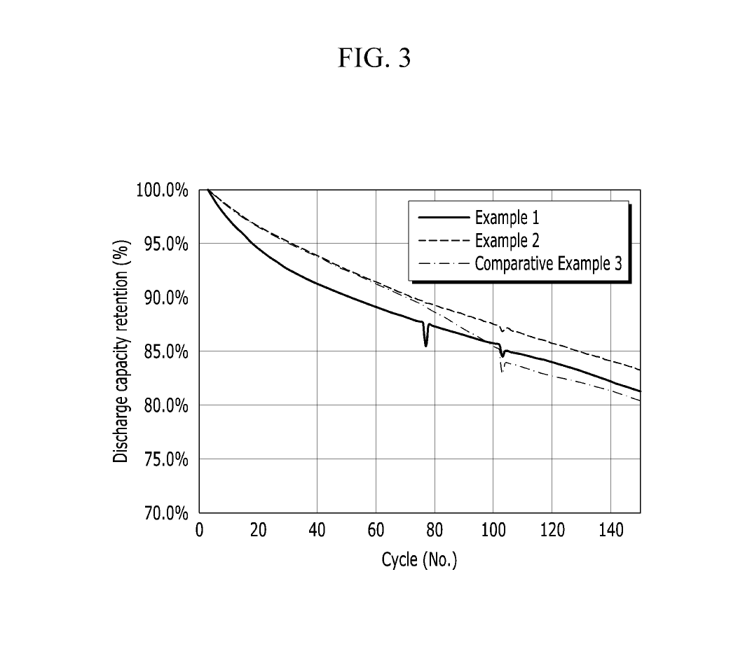

In addition, each negative electrode according to Examples 1 and 2 and Comparative Example 3, a LiₓNi_{y}Co_{z}MnₖO₂/LiCoO₂ mixture (30:70 wt %) positive electrode and the electrolyte solution were used to manufacture a rechargeable lithium battery cell having theoretical capacity of 2000 mAh. The rechargeable lithium battery cell was 150 times repetitively charged and discharged at 1 C and then, its discharge capacity retention was measured. The results are provided in FIG. 3. As shown in FIG. 3, the rechargeable lithium battery cells respectively using the negative electrodes of Examples 1 and 2 maintained greater than or equal to 80% of a discharge capacity retention over 140 cycles of the charge and discharge and thus, excellent cycle-life characteristics. On the contrary, the battery cell using the negative electrode of Comparative Example 3 showed excellent capacity retention similar to the battery cell of Example 2 at the initial cycle but sharply deteriorated capacity retention over about 100 cycles.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A negative active material for a rechargeable lithium battery, comprising
a Si-based alloy;
a first graphite material; and
a second graphite material having a different average particle diameter from the first graphite material.

2. The negative active material of claim 1, wherein a ratio of the average particle diameter of the first graphite material relative to that of the second graphite material is about 0.5 to about 0.92.

3. The negative active material of claim 1, wherein the average particle diameter of the first graphite material is about 8 μm to about 28 μm.

4. The negative active material of claim 1, wherein the average particle diameter of the second graphite material is about 10 μm to about 30 μm.

5. The negative active material of claim 1, wherein a weight ratio of the first graphite material and second graphite material is about 1:0.9 to about 9:0.1.

6. The negative active material of claim 1, wherein an amount of the Si-based alloy is about 5 wt % to about 25 wt % based on the total amount 100 wt % of the negative active material.

7. The negative active material of claim 1, wherein the Si-based alloy is Si-Q, wherein Q is selected from an alkali metal, an alkaline-earth metal, a Group 13 element, a Group 14 element, a Group 15 element, a Group 16 element, a transition metal, a rare earth element and a combination thereof, but not Si.

8. The negative active material of claim 1, wherein an amount of the first graphite material may be about 50 wt % to about 90 wt % based on the total amount 100 wt % of the negative active material.

9. The negative active material of claim 1, wherein an amount of the second graphite material may be about 5 wt % to about 45 wt % based on the total amount 100 wt % of the negative active material.

10. The negative active material of claim 1, wherein the Si-based alloy is a Si—Fe alloy.

11. A rechargeable lithium battery comprising:
the negative electrode comprising the negative active material of claim 1;
a positive electrode including a positive active material; and
a non-aqueous electrolyte.

12. The rechargeable lithium battery of claim 11, wherein the negative active material layer comprises of about 95 wt % to about 99 wt % of negative active material based on the total weight of the negative active material layer.

13. The rechargeable lithium battery of claim 11, comprises of the negative active material wherein a ratio of the average particle diameter of the first graphite material relative to that of the second graphite material is about 0.5 to about 0.92.

14. The rechargeable lithium battery of claim 11, comprises of the negative active material wherein the average particle diameter of the first graphite material is about 8 μm to about 28 μm.

15. The rechargeable lithium battery of claim 11, comprises of the negative active material wherein the average particle diameter of the second graphite material is about 10 μm to about 30 μm.

16. The rechargeable lithium battery of claim 11, comprises of the negative active material wherein a weight ratio of the first graphite material and second graphite material is about 1:0.9 to about 9:0.1.

17. The rechargeable lithium battery of claim 11, comprises of the negative active material wherein an amount of the Si-based alloy is about 5 wt % to about 25 wt % based on the total amount 100 wt % of the negative active material.

18. The rechargeable lithium battery of claim 11, comprises of the negative active material wherein the Si-based alloy is Si-Q, wherein Q is selected from an alkali metal, an alkaline-earth metal, a Group 13 element, a Group 14 element, a Group 15 element, a Group 16 element, a transition metal, a rare earth element and a combination thereof, but not Si.

19. The rechargeable lithium battery of claim 11, comprises of the negative active material wherein an amount of the first graphite material may be about 50 wt % to about 90 wt % based on the total amount 100 wt % of the negative active material.

20. The rechargeable lithium battery of claim 11, comprises of the negative active material wherein an amount of the second graphite material may be about 5 wt % to about 45 wt % based on the total amount 100 wt % of the negative active material.
